(19) United States
(12) Patent Application Publication
(10) Pub. No.: US 2011/0149510 A1
(43) Pub. Date: Jun. 23, 2011

(54) Adjustable Laptop Holder

(75) Inventors: Fabian A. Monsalve, Brooklyn, NY (US); Jane Abernethy, Ottawa (CA); Jordi Borras, Brooklyn, NY (US); Manuel Saez, Brooklyn, NY (US); Lachezar Tsvetanov, Stamford, CT (US)

(73) Assignee: HUMANSCALE CORPORATION, New York, NY (US)

(21) Appl. No.: 12/646,482

(22) Filed: Dec. 23, 2009

(51) Int. Cl. G06F 1/16; F16M 11/22

(52) U.S. Cl. 361/679.55; 248/158

(57) ABSTRACT

An adjustable laptop holder having an adjustable tray so as to allow a user to adjust the height of a laptop screen. The adjustable laptop can comprise a base, a shaft, a tray, a friction pack, and a clutch bearing. The friction pack attaches the shaft to the base. The clutch bearing has an inner race coupled to the shaft and an outer race which engages the tray. The adjustable laptop holder having features of the present invention allows a user to freely rotate the tray into the open position yet resists returning to the closed position, effectively locking the laptop holder in the desired position.

### I. BACKGROUND

Technological innovation over the last 15 years has done little to change the way most people usually interact with their personal computers, which is generally by sitting in front of a keyboard, mouse and monitor. The problem with the traditional method for a human interacting with their personal computer is that the human body is not suited to sitting for hours at a time, particularly while typing, pointing, clicking, and staring at an illuminated screen. This combination is further frustrated in that it can lead to muscle strain, fatigue and stress. Still, experts in ergonomics say there are several easy and effective ways in which computer users can improve their physical comfort, fight fatigue, and reduce the risk of injuries from repetitive motions.

Laptop computers are popular alternatives to desktop computers. However, the more that laptop computers are made to do the job of desktop computers, the more that their virtues, such as a small form factor and integrated keyboard and display, become liabilities. For example, the user must stare down at the display of the laptop computer while using the keyboard. This becomes fatiguing after more than just casual use.

Posture is one area in which minor adjustments can quickly yield benefits. Even at home, but especially in a more stressful environment like an office, users may force their bodies into rigid positions that result in fatigue, muscle strain, and, potentially, injury.

Maintaining what experts call optimal ergonomic positioning can increase energy levels and improve overall comfort, although it may take a few weeks before the results are noticeable. Good posture keeps the spine in what health professionals call the neutral position. Achieving a neutral position while seated upright in a chair with good lumbar support entails lifting the rib cage away from the hips, tucking in the belly, pulling the shoulders back, centering the weight of the head atop the spine and maintaining the lower back in a gentle C-shaped curve. Sustaining this position can help reduce muscle strain and relieve pressure on the lower back.

Beyond spinal posture, optimal ergonomic positioning requires tailoring the work area to fit the user's needs. Among things necessary to accomplish that is to position the monitor's top edge at eye level. This monitor position reduces muscle strain caused by the weight of your head leaning too far forward or backward.

Laptop users in particular should pay attention to screen height. Often the laptop screen is too low in relation to the user's eyes or the screen itself is very small, prompting the user to hunch forward to see text and images more clearly. A couple of hours in that position can significantly strain the muscles at the back of the neck and throughout the upper body.

Previous attempts have been made to design and develop a laptop holder which elevates the laptop display to a healthy and comfortable level. However, these attempts have either failed to adequately adjust to accommodate different-sized users, or required considerable effort to change the display height. For the foregoing reasons, there is a need for a laptop holder that allows a user to effortlessly adjust the laptop's display height across a range sufficient to accommodate different-sized users.

### II. SUMMARY

The invention disclosed herein is generally directed to a holder or mount for a mobile personal computer (i.e., laptop or notebook computer) having an adjustable tray so as to allow a user to adjust the height of the display screen to enable a comfortable, sustainable working posture. The adjustable laptop holder utilizes a single-motion locking mechanism which allows a user to freely rotate the tray into the open position yet resists returning to the closed position, effectively locking the laptop holder in the desired position.

An adjustable laptop holder having features of the present invention comprises a base, a shaft, a tray, a friction pack, and a clutch bearing. The friction pack attaches the shaft to the base. The clutch bearing has an inner race coupled to the shaft and an outer race which engages the tray.

In another version, the adjustable laptop holder has a base with an aperture, a shaft, a tray, a friction pack attaching the shaft to the base, and a one-way clutch bearing. The friction pack comprises a fastener, a hinge cap, a spring washer, a keyed washer, a bushing, and a stop. The fastener extends successively through the hinge cap, the spring washer, the keyed washer, the bushing, the aperture in the base, and the stop before engaging a threaded hole in the shaft. The one-way clutch bearing comprises an inner race coupled to the shaft and an outer race operatively engaging the tray. In this arrangement, the one-way clutch bearing allows the tray to rotate freely about the shaft in a first direction, yet transmits torque through the shaft to the friction pack when the tray is rotated about the shaft in a second direction. Due to friction between the friction pack and the base, the shaft will resist rotation and thereby cause the adjustable laptop holder's tray to be fixed at the user's desired position.

In another version, the adjustable laptop holder comprises a single-motion locking hinge mechanism and a laptop support. The single-motion locking hinge mechanism comprises a base, a shaft, a tray, a friction pack attaching the shaft to the base, and a clutch bearing. The laptop support attaches to the tray to secure a laptop on the adjustable laptop holder. The adjustable laptop holder can also comprise a cable management system, featuring a USB hub and one or more guides for routing the laptop's cables.

In yet another version, the adjustable laptop holder comprises a base, a shaft, a tray, a first friction pack, a second friction pack, a first one-way clutch bearing, and a second one-way clutch bearing. The base has a horizontal platform, a left vertical member, and a right vertical member. The shaft has first and second ends and is positioned between the left vertical member and the right vertical member of the base. The first friction pack attaches the first end of the shaft to the right vertical member of the base, while the second friction pack attaches the second end of the shaft to the left vertical member of the base. The first and second one-way clutch bearings each have an inner race coupled to the shaft and an outer race operatively engaging the tray. In this arrangement, the one-way clutch bearings allows the tray to rotate freely about the inner race in a first direction, yet transmit torque through the inner race to the shaft when the tray is rotated in a second direction.

The above summary is not intended to describe each illustrated embodiment or every possible implementation. These and other features, aspects, and advantages of the present invention will become better understood with regard to the following description, appended claims, and accompanying drawings.

### III. BRIEF DESCRIPTION OF THE DRAWINGS

FIG. 1 is a front perspective view of an embodiment of the adjustable laptop holder in an “open” position.

FIG. 2A is a front perspective view of an embodiment of the adjustable laptop holder showing the inner components of the adjustable laptop holder's single-motion locking hinge mechanism.

FIG. 2B is a front view of an embodiment of the adjustable laptop holder showing the inner components of the adjustable laptop holder's single-motion locking hinge mechanism while in the “closed” position.

FIG. 3A is an exploded rear view of an embodiment of the friction pack of the of the single-motion locking hinge mechanism.

FIG. 3B is an exploded, perspective rear view of the inner components of an embodiment of the single-motion locking hinge mechanism.

FIG. 4 is a front perspective view of an embodiment of the single-motion locking hinge mechanism showing the inner components of the present invention.

FIG. 5 is a front perspective view of an embodiment of the single-motion locking hinge mechanism showing the inner components of the present invention.

FIG. 6 is a cross-sectional view of an embodiment of the single-motion locking hinge mechanism showing the inner components.

FIG. 7 is a front perspective view of an embodiment of the adjustable laptop holder showing the tray in the open position.

FIG. 8 is an exploded view of an embodiment of the adjustable laptop holder.

FIG. 9 is a right-side view of an embodiment of the adjustable laptop holder showing the tray and port cover in the open position.

FIG. 10 is a front perspective view of a laptop being installed on the adjustable laptop holder.

FIG. 11 is a rear perspective view of a laptop mounted on the adjustable laptop holder showing cables being routed and connected to the laptop.

FIG. 12 is a ghosted front perspective view of a laptop mounted on the adjustable laptop holder showing the tray being tilted to the open position to adjust the height of the laptop screen.

FIG. 13 is a front perspective view of an alternative embodiment of the adjustable laptop holder showing the tray in the open position.

FIG. 14 is a ghosted front perspective view of the embodiment depicted in FIG. 13 showing the inner components of the adjustable laptop holder.

FIG. 15 is an exploded view of the embodiment depicted in FIG. 13 showing the inner components of the adjustable laptop holder.

FIG. 16 is a front view of an alternative embodiment of the adjustable laptop holder's single-motion locking hinge mechanism.

FIG. 17 is a front view of an alternative embodiment of the adjustable laptop holder's single-motion locking hinge mechanism.

FIG. 18 is a front view of an alternative embodiment of the adjustable laptop holder's single-motion locking hinge mechanism.

FIG. 19 is a front view of an alternative embodiment of the adjustable laptop holder's single-motion locking hinge mechanism.

FIG. 20 is a front view of an alternative embodiment of the adjustable laptop holder's single-motion locking hinge mechanism.

### IV. DESCRIPTION

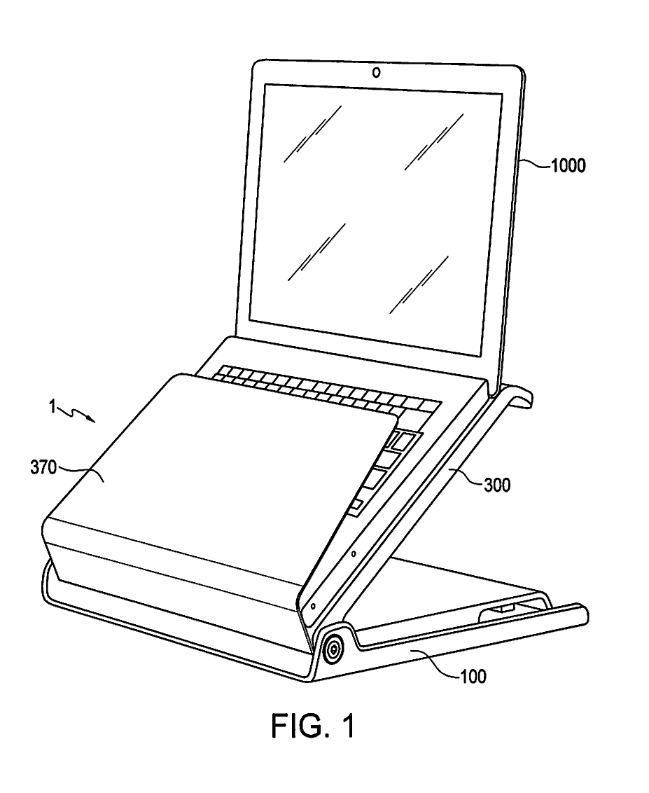

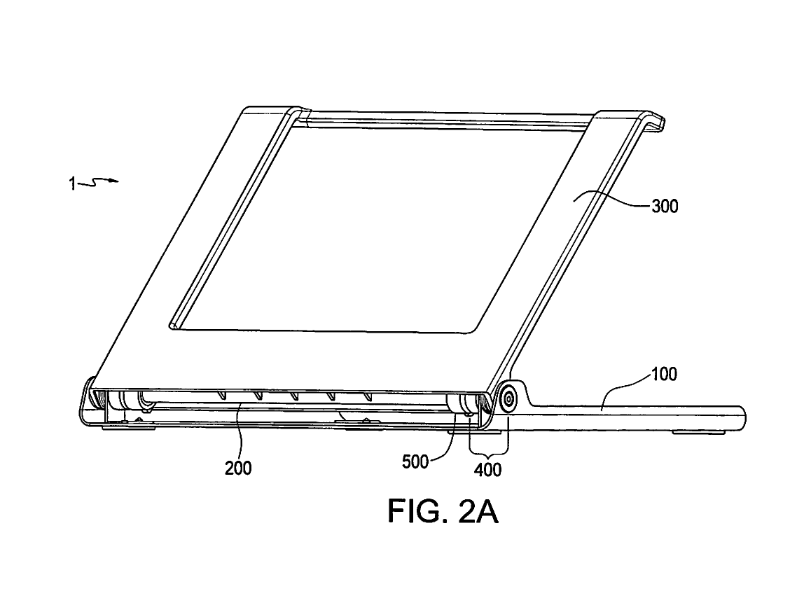

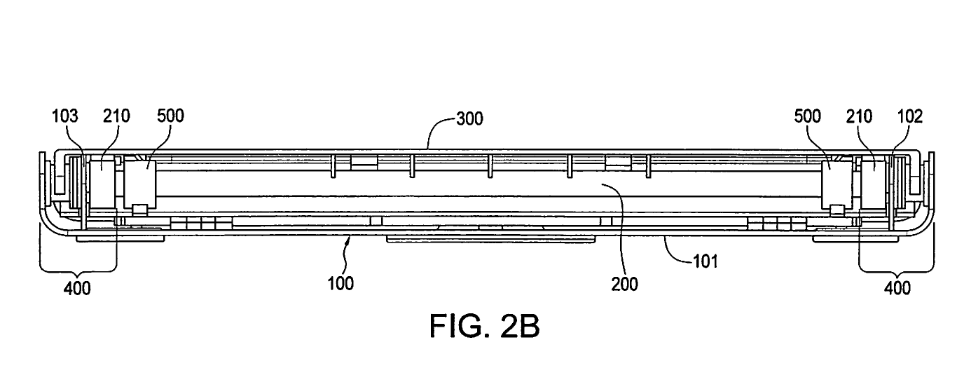

Referring to the embodiment depicted in FIG. 1, the adjustable laptop holder 1 described herein utilizes a single-motion locking hinge mechanism which allows a user to freely rotate (i.e., rotate with minimal resistance) the tray 300 into the open position yet resists returning to the closed position, effectively locking the laptop holder 1 in the desired position. Referring to FIGS. 2A and 2B, the adjustable laptop holder 1's single-motion locking hinge mechanism comprises a base 100, a shaft 200, a tray 300, a friction pack 400, and a clutch bearing 500.

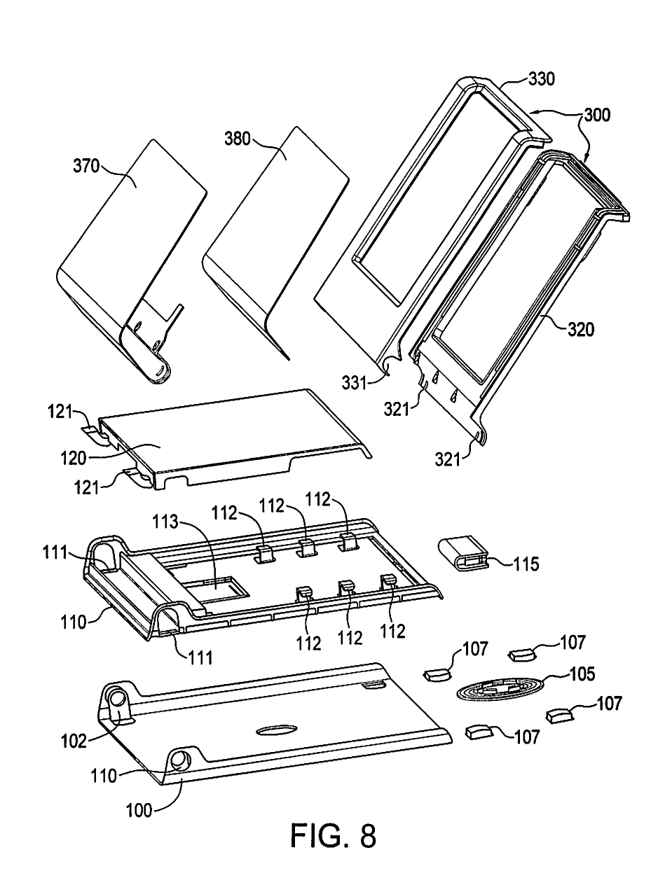

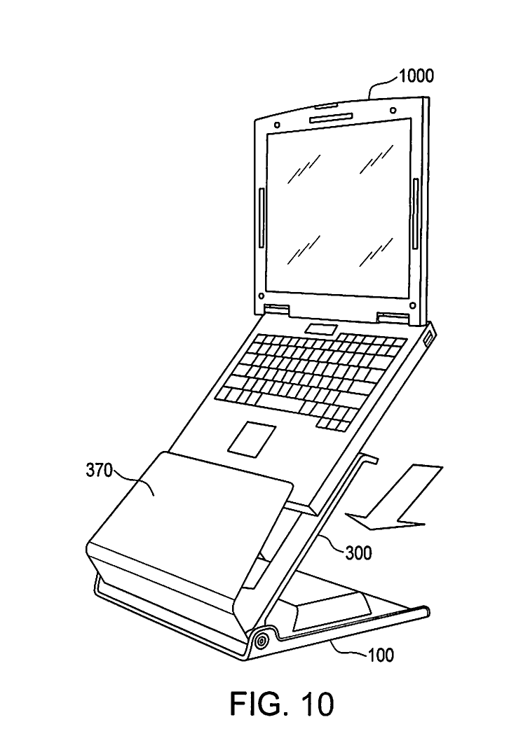

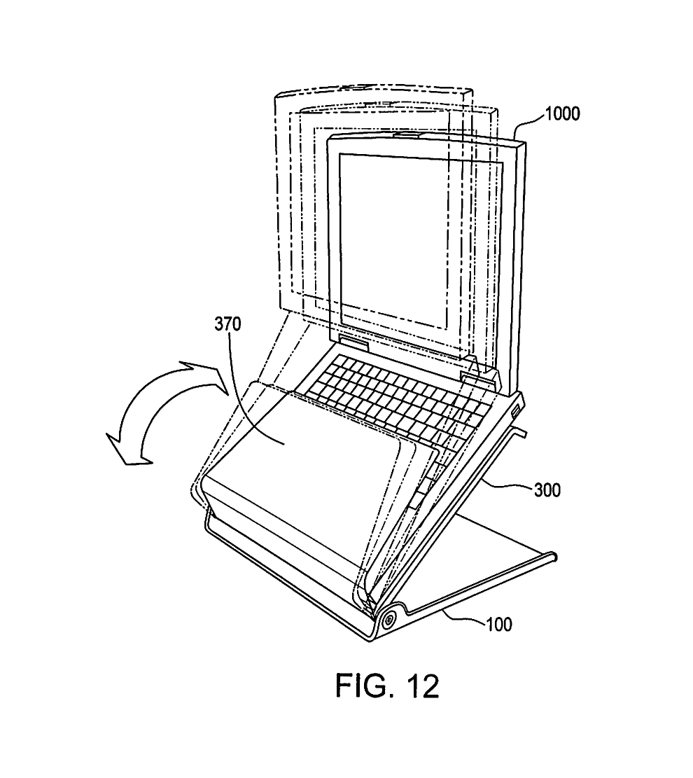

The base 100 can have a horizontal platform 101 interconnecting a right vertical member 102 and a left vertical member 103. In the embodiment depicted in FIGS. 1-9, the right and left vertical members 102, 103 are tabs cut out of the horizontal platform 101 and bent into a vertical position. In the embodiment depicted in FIGS. 10-12, the right and left vertical members 102, 103 are vertical side walls which can either be integral with the horizontal platform 101 or can be separate components fixedly attached to the horizontal platform 101 via welding, soldering, or any other means known in the art.

Referring to FIGS. 2-6, the shaft 200 is positioned between the right vertical member 102 and the left vertical member 103. The shaft 200 has a first end which is aligned with the aperture in the right vertical member 102 and a second end which is aligned with the aperture in left vertical member 103. Both ends of the shaft 200 can have a threaded hole.

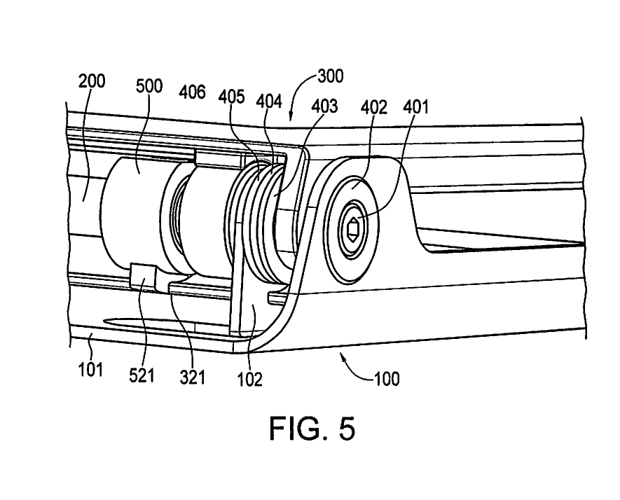

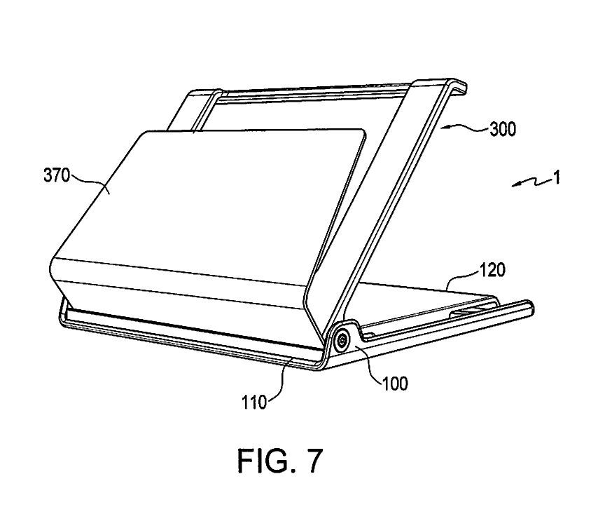

Referring to FIG. 2A and FIG. 5, the tray 300 is rotatably coupled to the shaft 200. The tray 300 can be molded as a single piece or can comprise several pieces attached by fasteners, clamps, adhesives, or any other means known in the art. For example, in the embodiment depicted in FIGS. 7-9, the tray 300 comprises a tray bottom 320 attached to a tray top 330.

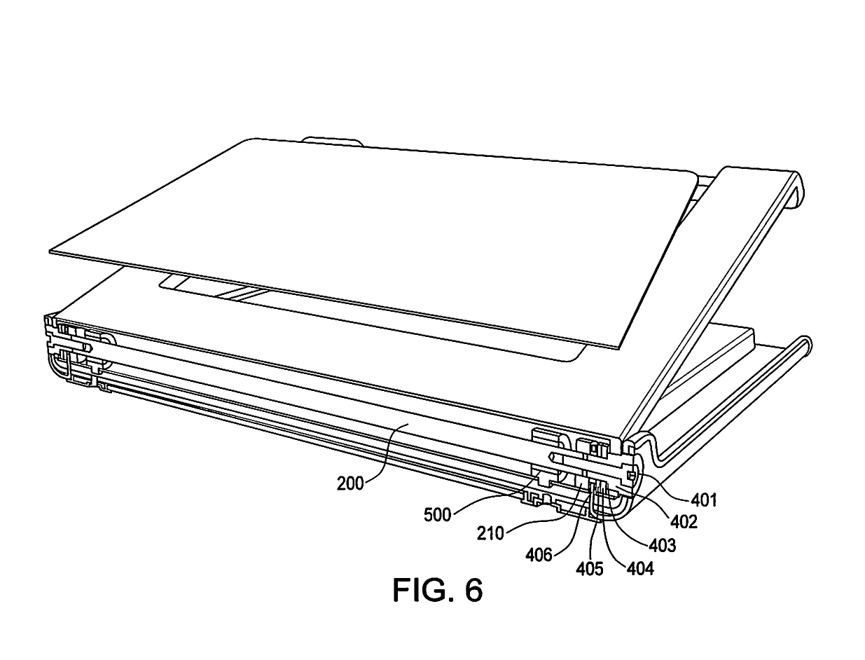

Referring to FIG. 5, the clutch bearing 500 has an inner race disposed around the shaft 200 and an outer race operatively coupled to the tray 300. The clutch bearing 500 can be a one-way clutch bearing which allows the outer race 501 to rotate freely (i.e., freewheel) about the inner race 502 in a first direction. When the outer race 502 is rotated in a second direction, the inner race 501 and outer race 502 lock such that the outer and inner races rotate together. In the embodiment depicted in FIGS. 5 and 6, the outer race 501 has a protrusion 521 which engages a notch 321 in the tray 300. In other embodiments, the outer race 501 can be bolted, welded, glued, or otherwise affixed to the tray 300 such that the outer race 501 rotates as the tray 300 rotates.

The friction pack 400 attaches the shaft 200 to the base 100. The friction pack 400 functions to provide resistance to the closing of the adjustable laptop holder 1. In one embodiment, a single friction pack 400 can be utilized to attach the shaft 200 to the base. In other embodiments, multiple friction packs may be utilized. For instance, in the embodiment depicted in FIGS. 1 and 2, a first friction pack 400 attaches the first end of the shaft 200 to the right vertical member 102, while a second friction pack 400 attaches the second end of the shaft 200 to the left vertical member 103.

In the embodiment depicted in FIGS. 2-6, the friction pack 400 comprises a fastener 401, a hinge cap 402, a spring washer 403, and a keyed washer 404, a bushing 405, and a stop 406. When assembled, the fastener 401 extends successively through the hinge cap 402, the spring washer 403, the keyed washer 404, the bushing 405, the aperture in the right vertical member 102, and the stop 406 to engage the threaded hole in the shaft 200.

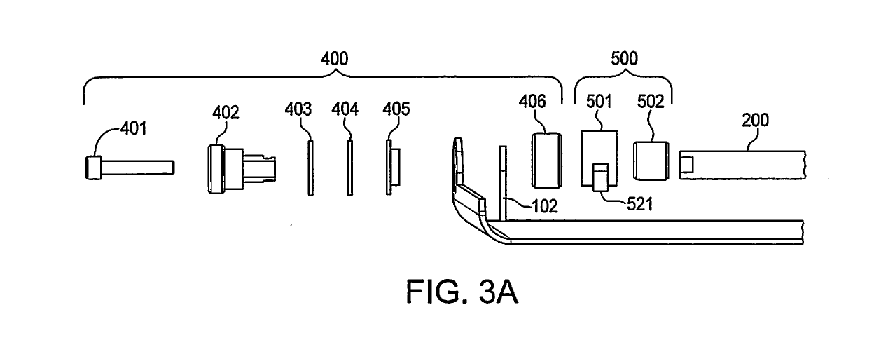

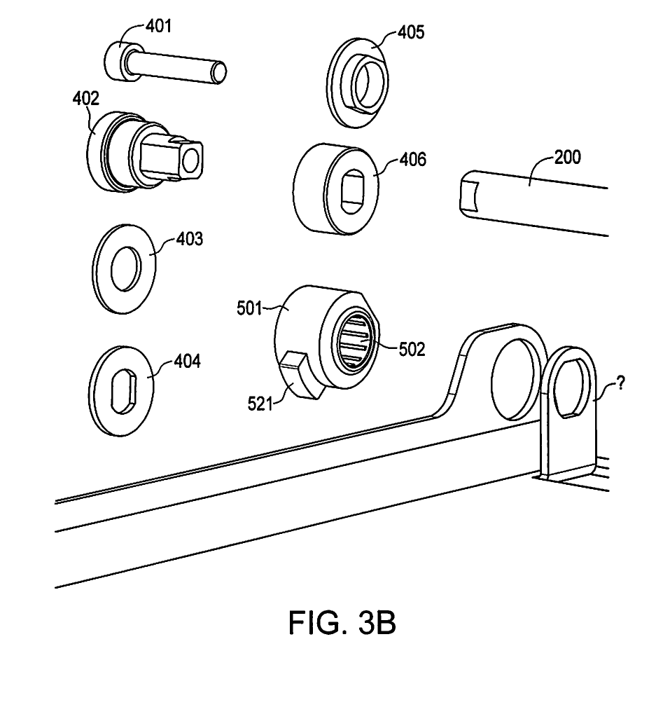

As depicted in FIGS. 3A and 3B, the hinge cap 402 has two distinct sections: a head and a body. The head of the hinge cap 402 is larger in diameter than the aperture in the vertical member 102, and the body of the hinge cap 402 is smaller in diameter than the aperture in the vertical member 102.

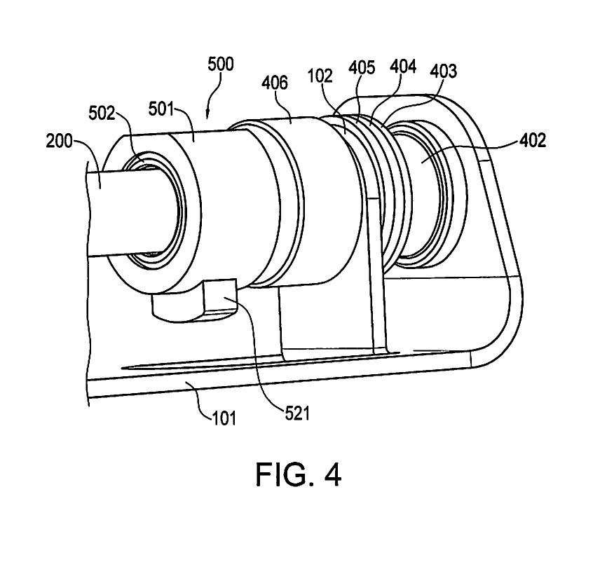

Referring to FIGS. 4-6, the keyed washer 404 can be mounted on the body of the hinge cap 402. As depicted in FIG. 3B, the keyed washer 404 can have a special-shaped (i.e., non-circular) hole which fits over a corresponding special-shaped body of the hinge cap 402. In this arrangement, the keyed washer 404 will not turn independently about the body of the hinge cap 402. In other words, the keyed washer 404 will turn as the hinge cap 402 turns.

Referring again to FIGS. 4-6, the spring washer 403 can be mounted on the body of the hinge cap 402 between the keyed washer 404 and the head of the hinge cap 402. The spring washer 403 provides a preload between the keyed washer and the head of the hinge cap 402, increasing the ability of a user to tune the friction pack 400 to provide the desired resistance. Various types of spring washers can be used, including but not limited to Belleville washers, bowed or curved washers, dome washers, crescent washers, wave washers, extension springs, and compression springs.

The bushing 405 can be fixedly coupled to the right vertical member 102. In the embodiment depicted in FIG. 3B, the bushing 405 has a non-circular flange or rib which engages the non-circular aperture in the right vertical member 102 to prevent the bushing 405's rotation with respect to the right vertical member 102. In other embodiments, the bushing 405 can be secured by welding, soldering, gluing, or any other known means in the art. Various types of bushings can be used, ranging from solid polymer bushings to oil impregnated self-lubricating bushings. (commonly referred to as Oilite bearings or bushings)

The stop 406 functions to connect the hinge cap 402 to the shaft 200, thereby synchronizing the rotation of the shaft 200 with the components of the friction pack 400. The stop 406 is engaged on one end by the shaft 200, and is engaged on the other end by the hinge cap 402. In the embodiment depicted in FIGS. 3A and 3B, the ends of both the shaft 200 and the hinge cap 402 are notched, keyed, or otherwise non-circular. The stop 406 has a corresponding notch for receiving the ends of the shaft 200 and hinge cap 402. In this arrangement, both the stop 406 and the hinge cap 402 will rotate as the shaft 200 rotates.

The fastener 401 can be a bolt, screw, or any other threaded fastener. In the embodiment depicted in FIGS. 2-6, the head of the fastener 401 is larger in diameter than the bore in the hinge cap 402, and the body of the fastener 401 is smaller in diameter than the bore in the hinge cap 402.

When the friction pack 400 is assembled, the keyed washer 404 will abut the bushing 405 to provide a first bearing surface, and the stop 406 will abut the inner periphery of the right vertical member 210 to provide a second bearing surface. The body of the fastener 401 will extend successively through the bore in the hinge cap 402, the spring washer 403 (which is mounted on the hinge cap 402), the keyed washer 404 (which is also mounted on the hinge cap 402), the bushing 405, the aperture in the right vertical member 102, and the stop 406 to engage the threaded hole in the shaft 200. The fastener 401 provides a clamping force between the keyed washer 404 and the bushing 405 and between the stop 406 and the inner periphery of the right vertical member 102. As the fastener 401 is tightened, the keyed washer 404 will be forced into contact with the bushing 405, and the stop 406 will also be forced into contact with the inner periphery of the right vertical member 102. As the friction at the first and second bearing surfaces increases, the resistance to the rotation of the shaft 200 increases.

The single-motion locking hinge mechanism of the adjustable laptop holder 1 operates as follows. As the user brings the laptop holder 1 into the open position, the rotation of the tray 300 in the first direction will drive the outer race 501 of the clutch bearing 500 to rotate freely about the inner race 502 in the first direction. However, the single-motion locking hinge mechanism of the adjustable laptop holder 1 provides resistance to the tray 300 returning to the closed position. Rotation of the tray 300 in the second direction will drive the outer race 501 of the clutch bearing 500 to rotate in the second direction. Because the inner race 501 and outer race 502 of the clutch bearing lock when rotated in the second direction, the rotation of the outer race 501 will drive the inner race 502 to rotate, which in turn causes the shaft 200 to rotate. The rotation of the shaft 200 will cause the hinge cap 402 to rotate since they are interconnected by the stop 406. The fastener 401, the spring washer 403, and the keyed washer 404 will rotate as the hinge cap 402 rotates. Because fastener 401 is exerting a clamping force between the keyed washer 404 and the bushing 405 and between the stop 406 and the inner periphery of the right vertical member 102, friction will exist at the first and second bearing surfaces. This friction, which can be adjusted by tightening or loosening the fastener 401, provides the resistance to the closing of the tray 300. When the fastener 401 is tightened to the appropriate tension, the single-motion locking hinge mechanism of the adjustable laptop holder 1 effectively locks the tray 300 in the desired position. The tray 300 will remain in the desired open position until the user applies a downward force to the tray 300 sufficient to overcome the resistance provided by the friction pack 400.

Referring to FIGS. 7-9, the adjustable laptop holder 1 can further comprise a laptop support 370 attached to the tray 300. The laptop support 370 functions to secure a laptop on the adjustable laptop holder 1. A protective insert 380 may also be attached to the inner surface of the laptop support 370 in order to protect the laptop's keyboard when mounted on the adjustable laptop holder 1.

Still referring to FIGS. 7-9, a base insert 110 can be slidably mounted onto the base 100. The base insert 110 has slots 111 through which the right and left vertical members 102, 103 of the base 100 can extend. The base insert 110 can be secured to the base 100 with fasteners, glue, or other means known in the art. The base insert 110 can further comprise a cable management system. The cable management system includes a dock 113 for housing a USB hub 115, as well as one or more guides 112 for routing cables to and from the laptop and the USB hub 115. A swivel base 105 and plastic feet 107 can also be mounted to the base 100 in an embodiment.

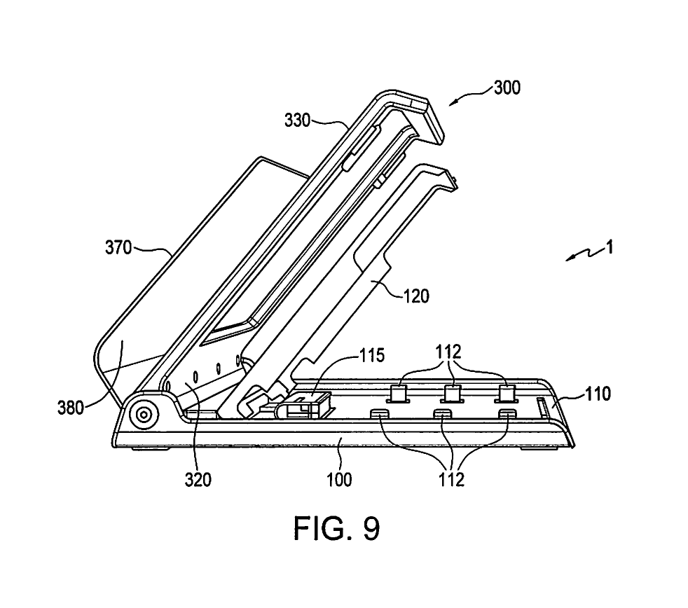

Still referring to FIGS. 7-9, a port cover 120 can also be mounted to the base insert 110 to provide an enclosure for the cable management system. The port cover 120 has one or more upwardly extending hooks 121 which engage one or more apertures in the base insert 110 (not shown) so as to allow the port cover 120 to pivot about the aperture(s). FIG. 7 shows the port cover 120 in the closed position, whereas FIG. 9 shows the port cover 120 in the open position.

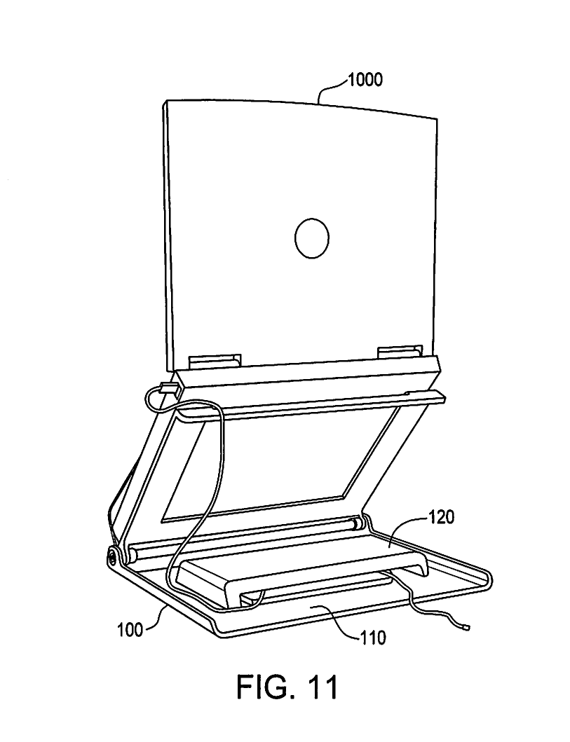

FIGS. 10-12 show a laptop computer 1000 being installed on the adjustable laptop holder 1. As depicted in FIG. 10, a user can install the laptop computer 1000 on the adjustable laptop holder 1 by sliding the laptop's keyboard (with the laptop in the open position) into the slot formed by the laptop support 370 and the tray 300. Next, as depicted in FIG. 11, the user can connect and route cables as necessary utilizing the base insert 110's cable management system. Lastly, the adjustable laptop holder's single-motion locking hinge mechanism allows the user to adjust and maintain the height of the laptop screen by incrementally tilting the tray 300 forward into the open position.

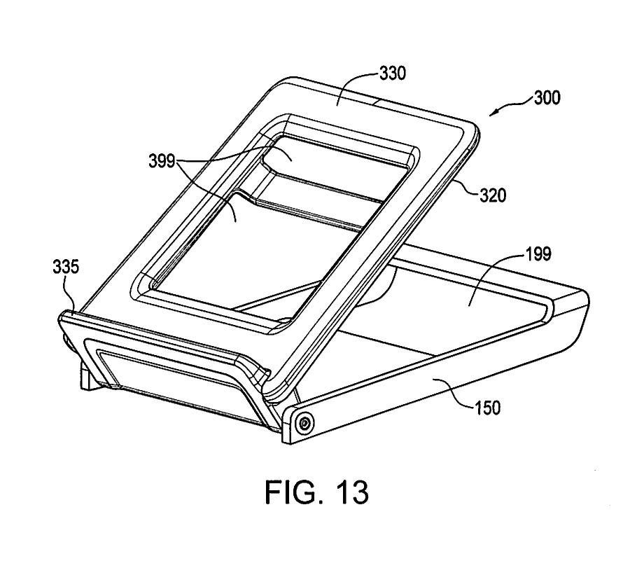

An alternative embodiment of the adjustable laptop holder 1 is shown in FIGS. 13-15. Referring to FIG. 13, the adjustable laptop holder 1 can comprise a tray 300 rotatably coupled to a base housing 150 via a shaft 200 (not shown). The tray 300 has a tray bottom 320 and a tray top 330. The tray top 330 has a lip 335 for securing a laptop on the adjustable laptop holder 1. The base housing 150 has a slot 199 to accommodate the attachment of cables, port replicators, USB hubs, and the like to the laptop. The tray 300 has one or more slots 399 to provide ventilation for the laptop.

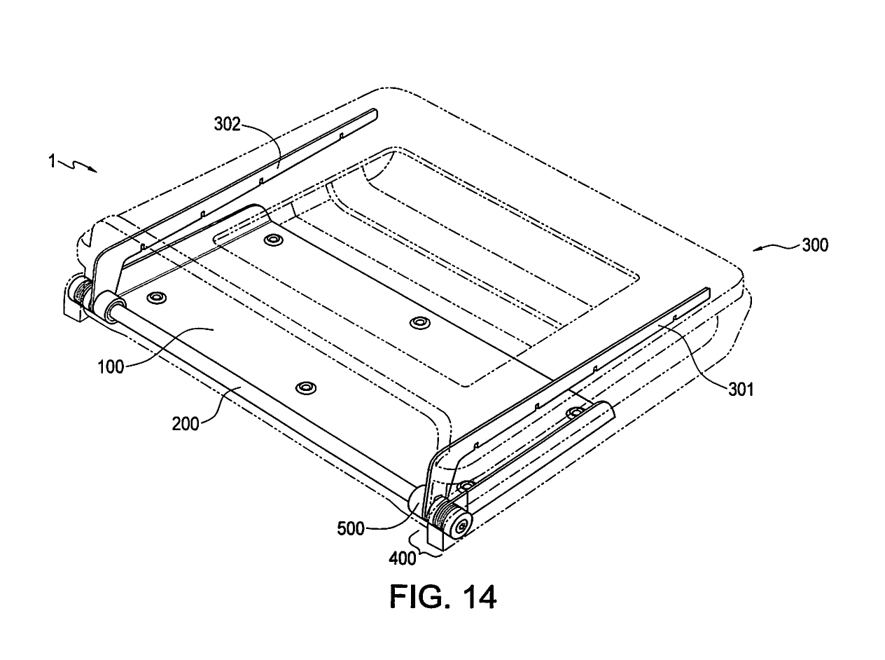

FIG. 14 reveals the inner components housed within the tray 300 and the base housing 150. The inner components include a base 100, a shaft 200, left and right tray support arms 301,302, and a single-motion locking hinge mechanism comprising a one-way clutch bearing 500 and a friction pack 400.

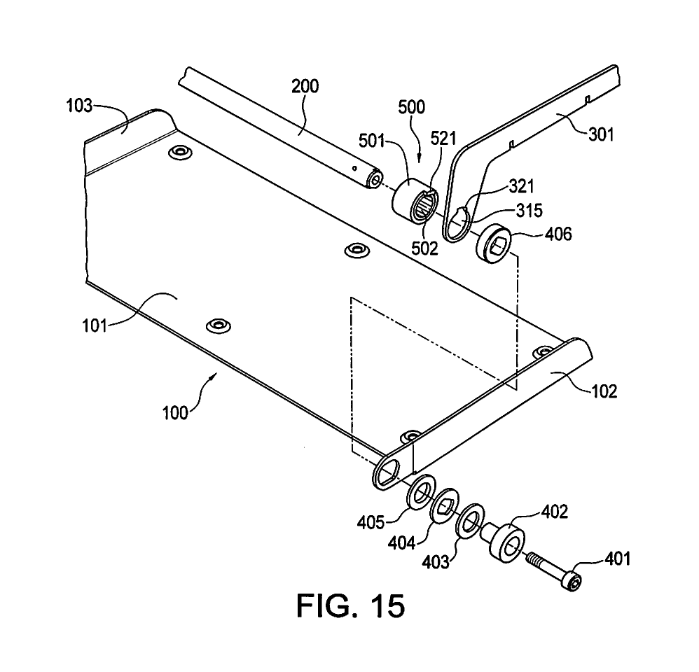

Referring to FIG. 15, the base 100 comprises a horizontal platform 101 interconnecting a right vertical member 102 and a left vertical member 103. The horizontal platform 101 can be constructed out of a dense metal or metal alloy such as iron, steel, stainless steel, copper, or brass in order to function as a ballast for the adjustable laptop holder 1. In other embodiments, the horizontal platform 101 can be constructed out of a less dense metal or even plastic, yet still be ballasted by incorporating inserts of dense material such as tungsten. The base housing 150 can be attached to the base 100 by fasteners, gluing, or any other means known in the art.

Still referring to FIG. 15, tray 300 can comprise a right tray support arm 301 and a left tray support arm 302 positioned between the tray top 330 and the tray bottom 320. The right and left tray support arms 301, 302 rotatably couple the shaft 200. The first end of the shaft 200 extends through an aperture 315 in right arm 301, and the second end of the shaft 200 extends through aperture 315 (not shown) in the left arm 302. Each aperture 315 has a notch 321 which is engaged by the protrusion 521 on the outer race 501 of the clutch bearing 500. In this arrangement, the right and left tray support arms 301, 302 will drive the outer race 501 of the clutch bearing 500 as the arms 301,302 rotate about the shaft 200.

The embodiment depicted in FIGS. 13-15, like the embodiments depicted in FIGS. 4-6, features a friction pack 400 comprising a fastener 401 extending successively through a hinge cap 402, a spring washer 403, a keyed washer 404, a bushing 405, the aperture in the right or left vertical member 102, 103, and a stop 406 before engaging the shaft 200. Accordingly, the embodiment depicted in FIGS. 10-12 will operate in a similar fashion as described above to allow a user to adjust the height of a laptop screen positioned on the laptop holder 1.

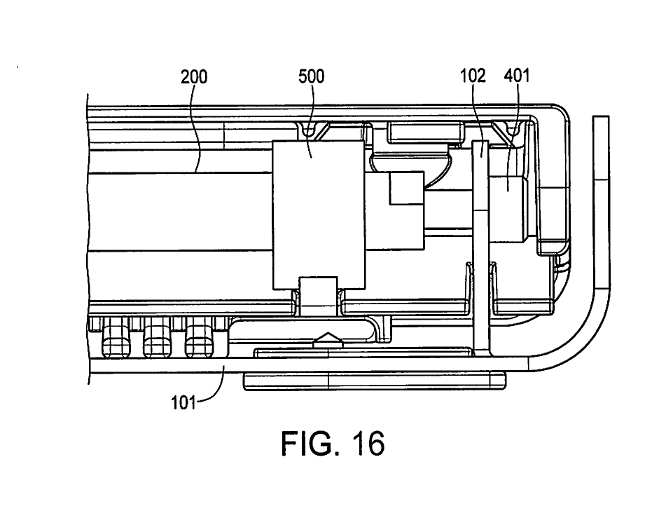

Exemplar alternative embodiments of the single-motion locking hinge mechanism of the adjustable laptop holder 1 are shown in FIGS. 16-20. FIGS. 16-20 depict alternative configurations utilizing the fastener 401, the hinge cap 402, the spring washer 403, the keyed washer 404 the bushing 405, and the stop 406 separately or in combination with one or more of the other components. In FIG. 16, the friction pack 400 comprises the fastener 401 extending through the aperture in the right vertical member 102 to threadingly engage the shaft 200. In this embodiment, the head of the fastener 401 abuts the outer periphery of the right vertical member 102 to form the bearing surface. In lieu of the stop 406, the distal end of the hinge cap 402 and the shaft 200 can be notched or keyed as described herein, or the hinge cap 402 can be attached to the shaft 200 by bolts, pins, adhesives, or any other means known in the art. As the fastener 401 is tightened, the friction between the head of the fastener 401 and the outer periphery of the right vertical member 102 increases to provide resistance to the closing of the tray 300.

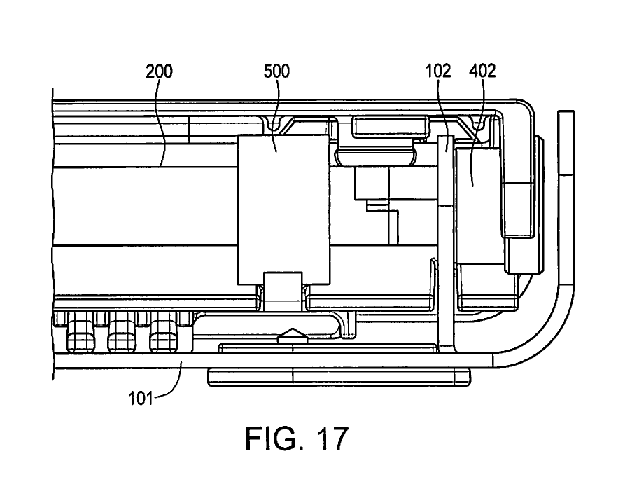

In FIG. 17, the friction pack 400 comprises the fastener 401 extending through the hinge cap 402 and the aperture in the right vertical member 102 to threadingly engage the shaft 200. In this embodiment, the head of the hinge cap 402 abuts the outer periphery of the right vertical member 102 to form the bearing surface.

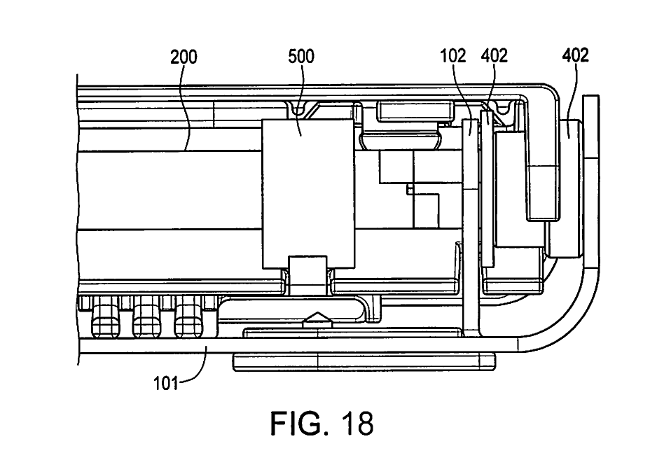

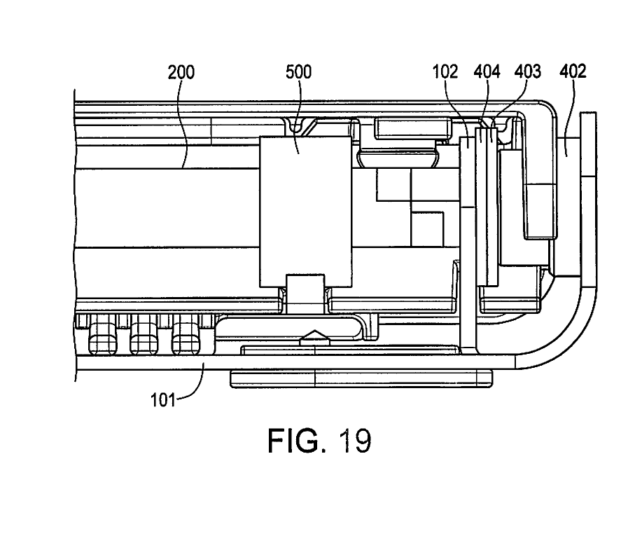

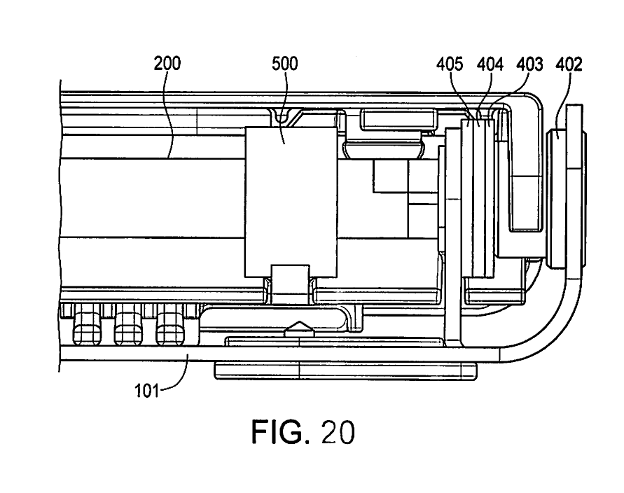

In FIG. 18, the friction pack 400 comprises the fastener 401, the hinge cap 402, and the keyed washer 404. In FIG. 19, the friction pack 400 comprises the fastener 401, the hinge cap 402, the spring washer 403, and the keyed washer 404. In FIG. 20, the fastener 401 extends through the hinge cap 402, the spring washer 403, the keyed washer 404, the bushing 405, and the aperture in the right vertical member 102 to threadingly engage the shaft 200.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An adjustable support mechanism, comprising:
a. a base;
b. a shaft;
c. a tray;
d. a friction pack attaching the shaft to the base; and
e. a one-way clutch bearing comprising an inner race coupled to the shaft and an outer race engaging the tray.

2. The adjustable support mechanism of claim 1, wherein the base comprises a horizontal platform having at least one vertical member, wherein the vertical member has an aperture.

3. The adjustable support mechanism of claim 2, wherein the friction pack comprises a fastener.

4. The adjustable support mechanism of claim 3, wherein the fastener defines a head and a body, the body of the fastener extending through the aperture in the vertical member to threadingly engage the shaft.

5. The adjustable support mechanism of claim 2, wherein the friction pack comprises:
a. a hinge cap defining a head and a body, the body of the hinge cap extending through the aperture in the vertical member and fixedly coupling the shaft; and
b. a fastener extending through the hinge cap and threadingly engaging a hole in the shaft.

6. The adjustable support mechanism of claim 5, wherein the head of the hinge cap frictionally engages the vertical member of the base.

7. The adjustable support mechanism of claim 6, wherein the friction pack further comprises a stop defining a first end and a second end, the first end fixedly coupled to the body of the hinge cap, the second end fixedly coupled to the shaft such that the stop and hinge cap rotate as the shaft rotates.

8. The adjustable support mechanism of claim 4, wherein the friction pack further comprises a keyed washer positioned between the head of the fastener and the aperture in the vertical member.

9. The adjustable support mechanism of claim 5, wherein the friction pack further comprises a keyed washer mounted to the body of the hinge cap.

10. The adjustable support mechanism of claim 9, wherein the keyed washer frictionally engages the vertical member of the base.

11. The adjustable support mechanism of claim 5, wherein the friction pack further comprises a bushing attached to the vertical member.

12. The adjustable support mechanism of claim 9, wherein the friction pack further comprises a bushing attached to the vertical member.

13. The adjustable support mechanism of claim 11, wherein the keyed washer frictionally engages the bushing.

14. The adjustable support mechanism of claim 6, wherein the head of the hinge cap frictionally engages the outer periphery of the vertical member of the base, and wherein the stop frictionally engages the inner periphery of the vertical member of the base.

15. The adjustable support mechanism of claim 8, wherein the friction pack further comprises a spring washer positioned between the head of the fastener and the keyed washer.

16. The adjustable support mechanism of claim 9, wherein the friction pack further comprises a spring washer positioned between the head of the hinge cap and the keyed washer.

17. The adjustable support mechanism of claim 13, wherein the friction pack further comprises a spring washer positioned between the head of the hinge cap and the keyed washer.

18. The adjustable support mechanism of claim 2, wherein the outer race of the one-way clutch bearing comprises a protrusion which operatively engages a notch in the tray such that the outer race rotates as the tray rotates about the shaft.

19. The adjustable support mechanism of claim 17, wherein the outer race of the one-way clutch bearing comprises a protrusion which operatively engages a notch in the tray such that the outer race rotates as the tray rotates about the shaft.

20. The adjustable support mechanism of claim 19, wherein the outer race of the one-way clutch bearing rotates freely about the inner race of the one-way clutch bearing as the tray rotates about the shaft in a first direction, and wherein the outer race and inner race of the one-way clutch bearing lock as the tray rotates in a second direction to drive the shaft in the second direction.

21. The adjustable support mechanism of claim 20, wherein the rotation of the shaft in a second direction drives the stop and hinge cap to rotate in a second direction such that the keyed washer frictionally engages the bushing and the stop frictionally engages the inner periphery of the vertical member of the base.

22. The adjustable support mechanism of claim 2, wherein the friction pack comprises a fastener extending through a hinge cap and the aperture in the vertical member to engage a threaded hole in the shaft.

23. The adjustable support mechanism of claim 22, wherein the hinge cap defines a head and a body, the body of the hinge cap extending through the aperture in the vertical member to fixedly couple to a stop.

24. The adjustable support mechanism of claim 23, wherein the friction pack further comprises a keyed washer positioned between the head of the hinge cap and the vertical member.

25. The adjustable support mechanism of claim 24, wherein the friction pack further comprises a bushing positioned between the keyed washer and the vertical member.

26. The adjustable support mechanism of claim 25, wherein the friction pack further comprises a spring washer positioned between the head of the hinge cap and the keyed washer.

27. The adjustable support mechanism of claim 26, wherein the friction pack further comprises a stop defining a first end and a second end, the first end of the stop fixedly coupled to the hinge cap, the second end of the stop fixedly coupled to the shaft such that the stop and hinge cap rotate as the shaft rotates.

28. An adjustable support mechanism, comprising:
a. a base having an aperture;
b. a shaft;
c. a tray;
d. a friction pack attaching the shaft to the base, the friction pack comprising a fastener, a hinge cap, a spring washer, a keyed washer, a bushing, and a stop, wherein the fastener extends successively through the hinge cap, the spring washer, the keyed washer, the bushing, the aperture in the base, and the stop to engage the shaft; and
e. a one-way clutch bearing comprising an inner race coupled to the shaft and an outer race operatively engaging the tray, wherein the one-way clutch bearing allows the tray to rotate freely about the inner race in a first direction, yet transmits torque through the inner race to the shaft when the tray is rotated in a second direction.

29. An adjustable support mechanism, comprising:
a. a base defining a horizontal platform, a left vertical member, and a right vertical member;
b. a shaft positioned between the left vertical member and the right vertical member, the shaft defining a first end and a second end;
c. a tray;
d. a first friction pack attaching the first end of the shaft to the right vertical member of the base, the first friction pack comprising a first fastener extending successively through a first hinge cap, a first spring washer, a first keyed washer, a first bushing, the right vertical member, and a first stop to engage the first end of the shaft;
e. a second friction pack attaching the second end of the shaft to the left vertical member of the base, the second friction pack comprising a fastener extending successively through a second hinge cap, a second spring washer, a second keyed washer, a second bushing, the left vertical member, and a second stop to engage the second end of the shaft;
f. a first one-way clutch bearing comprising an inner race coupled to the shaft and an outer race operatively engaging the tray; and
g. a second one-way clutch bearing comprising an inner race coupled to the shaft and an outer race operatively engaging the tray.

30. An adjustable laptop holder, comprising:
a. a single-motion locking hinge mechanism, comprising:
i. a base;
ii. a shaft;
iii. a tray;
iv. a friction pack attaching the shaft to the base; and
v. a one-way clutch bearing comprising an inner race coupled to the shaft and an outer race engaging the tray;
b. a laptop support attached to the tray to secure a laptop on the adjustable laptop holder.

31. The adjustable laptop holder of claim 30, further comprising a protective insert attached to the laptop support.

32. The adjustable laptop holder of claim 30, wherein the tray further comprises a tray bottom attached to a tray top.

33. The adjustable laptop holder of claim 32, wherein the tray bottom comprises a notch operatively engaged by a protrusion of the outer race of the one-way clutch bearing such that rotation of the tray drives the outer race of the one-way clutch bearing to rotate about the shaft.

34. The adjustable laptop holder of claim 30, further comprising a base insert mounted on the base.

35. The adjustable laptop holder of claim 34, wherein the base insert comprises a cable management system, the cable management system comprising a dock for mounting a USB hub and one or more cable-routing guides.

36. The adjustable laptop holder of claim 30, further comprising a swivel attached to the base.

37. The adjustable laptop holder of claim 34, further comprising a port cover mounted to the base insert.

38. The adjustable laptop holder of claim 37, wherein the port cover has one or more upwardly extending hooks engaging one or more apertures in the base insert so as to allow the port cover to pivot about the base insert to define an open position and a closed position.

39. An adjustable support mechanism, comprising:
a. a base;
b. a shaft attached the base;
c. a tray;
d. a one-way clutch bearing comprising an inner race coupled to the shaft and an outer race operatively engaging the tray, wherein the one-way clutch bearing allows the tray to rotate freely about the inner race in a first direction, yet transmits torque through the inner race to the shaft when the tray is rotated in a second direction; and
e. a means for providing resistance to the rotation of the shaft in the second direction.
